(19) United States
(12) Patent Application Publication
(10) Pub. No.: US 2025/0280751 A1
(43) Pub. Date: Sep. 11, 2025

(54) Agricultural Machine

(71) Applicant: Amazonen-Werke H. Dreyer SE & Co. KG, Hasbergen (DE)

(72) Inventor: Danijel BOROVAC, Oldenburg (DE)

(73) Assignee: Amazonen-Werke H. Dreyer SE & Co. KG, Hasbergen (DE)

(21) Appl. No.: 18/566,346

(22) PCT Filed: May 23, 2022
(86) PCT No.: PCT/EP2022/063861

§ 371 Date: Apr. 23, 2024

(30) Foreign Application Priority Data
Jun. 1, 2021 (DE) 10 2021 114 108.7

(51) Int. Cl. F16C 17/02; A01B 59/00

(52) U.S. Cl. CPC F16C 17/02; A01B 59/002

(57) ABSTRACT

Agricultural machine comprising at least one support frame associated with the machine with at least one receptacle for at least one crossbeam aligned at least substantially to be transverse to a direction of travel of the machine, as well as at least one bearing device by way of which the crossbeam is arranged at the receptacle to be rotatable at least in part about its longitudinal axis, wherein the bearing device comprises at least one shell element which, when viewed in particular in the circumferential direction, comprises an outer side facing the receptacle and an inner side facing the crossbeam, wherein at least one compensating body by way of which the crossbeam is connected in a rotationally fixed manner to the bearing device, in particular to the shell element, is arranged between the inner side and the crossbeam. In order to obtain a particularly variable connection between the bearing device and the crossbeam, it is provided that the shell element and the compensating body are configured such that the bearing device, in particular the shell element and/or the compensating body, in an assembled state, is/are braced with the crossbeam, in particular in a force-fit manner and/or in the manner of a clamping connection.

### CROSS REFERENCE TO RELATED APPLICATIONS

The present application claims priority under 35 U.S.C. § 365 to PCT/EP2022/063861 filed on May 23, 2022 and under 35 U.S.C. § 119(a) to German Application No. 10 2021 114 108.7 filed on Jun. 1, 2021.

### BACKGROUND

The Disclosure relates to an agricultural machine.

A plurality of variants of trailed, mounted, and/or self-propelled machines is known in the field of agriculture. In addition to sowing machines that are suitable for spreading distribution material, in particular seeds and/or fertilizer on the agricultural arable land, this includes among other things soil cultivation machines by way of which the topsoil of such arable land can be prepared and/or post-processed. This additionally includes tilling combinations consisting of a sowing machine and a soil cultivation machine which are configured to combine the distribution of spreading materials and the cultivation of the arable land. In order to spread the distribution material accordingly on the arable land or to process the arable land accordingly, such agricultural machines comprise at least one work tool that is suitable for this purpose and that is suitably coupled with a support frame of the implement.

Generic work tools can be positioned and/or moved at least in part to different heights depending on the position of the machine, in particular between a work and/or transport position, and/or depending on the required working or penetration depth. For this purpose, such work tools, in particular in a plurality seen transverse to a direction of travel of the machine, are arranged to be adjustable in height, position, and/or orientation by way of at least one, in particular common, crossbeam coupled to the machine.

A generic machine is described, for example, in EP 3 649 841 A1. The machine comprises at least one support frame that is associated with the machine and has at least one receptacle for at least one crossbeam aligned substantially transverse to a direction of travel of the machine. Furthermore, the machine comprises at least one, in particular multi-part, bearing device by way of which the crossbeam is arranged at the receptacle so as to be rotatable at least in part about its longitudinal axis. The bearing device further comprises a shell element which, in particular when viewed in the circumferential direction, comprises an outer side facing the receptacle and an inner side facing the crossbeam. Furthermore, at least one compensating body by way of which the crossbeam is connected in a rotationally fixed manner to the bearing device, in particular to the shell element, is arranged between the inner side and the crossbeam.

The problems with such a machine configured in this way is inter alia the way in which the support frame, in particular the bearing device, is coupled to the crossbeam. An embodiment variant in which the compensating body is connected, in particular exclusively, to the crossbeam in the manner of a positive-fit connection is particularly disadvantageous due to the associated and/or necessary play between the bearing device, in particular the compensating body, and the crossbeam. This leads to particularly high, in particular additional, loads on the bearing device and/or the crossbeam, in particular in the event of load changes and/or fluctuations, which in turn has a negative effect on the operational safety of the machine. A further embodiment variant in which the compensating body is connected to the crossbeam in a positive substance-fit manner, in particular in the manner of a welded connection, is disadvantageous due to the lack of adaptability with regard to the in particular axial position at which the compensating body is connected to the crossbeam. Subsequent adjustment of a position of the crossbeam relative to the support frame of the machine is no longer possible at all or only possible with considerable effort.

### SUMMARY

The object underlying the disclosure is therefore to design a machine in such a way that the disadvantages described are eliminated at least in part. In particular, a particularly variable connection between the bearing device and the crossbeam is to be achieved and at the same time be particularly reliable during operation.

This object is satisfied according to the disclosure in that the shell element and the compensating body are configured such that the bearing device, in particular the shell element and/or the compensating body, in an assembled state is braced with the crossbeam, in particular in a force-fit manner and/or in the manner of a clamping connection.

As a result of this measure, the bearing device, in particular the compensating body, is at least almost free of play and can still be connected or is connected to the crossbeam in a reversible and/or non-destructive manner. Depending on the required and/or intended position of the rows along the arable land and/or the associated row-related work tools, which are preferably arranged as a plurality at the crossbeam, the crossbeam can therefore be repositioned in the axial direction and/or along its longitudinal axis relative to the receptacle. For this purpose, the compensating body and the installed crossbeam can be detached from one another before or during a work process and can be slidable, in particular axially, relative to one another. When furthermore the position of the receptacle and therefore of the bearing device is fixedly defined, for example, relative to the support frame, the crossbeam and therefore in particular the work tools can continue to be easily adaptable in terms of position, attitude and/or orientation relative to the support frame. This allows the crossbeam and therefore in particular the work tools to be easily adapted to the conditions or the needs of the arable land, which means that a particularly high level of flexibility of the machine has been reached.

The compensating body is preferably arranged with at least one of its sides abutting directly at the shell element and with at least one other side directly at the crossbeam and is there configured to compensate for the size and/or shape tolerances between the crossbeam and the bearing device, in particular the shell element. This allows the bearing devices to be at least substantially reused or retained in the event of varying crossbeams that differ from one another in terms of their size and/or shapes by exchanging the compensating bodies despite the varying crossbeams. This embodiment is particularly inexpensive and/or easy to assemble. Furthermore, a contour or shape on one side of the compensating body corresponds at least substantially to a contour or shape of the shell element, while another contour or shape on another side of the compensating body corresponds at least substantially to a contour or shape of the crossbeam. This allows the receptacle and the crossbeam to be arranged thereon to differ in size and/or shape, since this difference is compensated for by the compensating body.

In a preferred embodiment, the compensating body and/or the shell element are formed at least in part from metallic material, in particular from steel and/or from an advantageous alloy, for example, copper alloys or the like. Alternatively or additionally, the compensating body and/or the shell element can be formed at least in part from plastic material, in particular fiber-reinforced material. Furthermore, alternatively or additionally, combinations of different material pairings are also conceivable in which the compensating body and the shell element are formed at least in part from different materials.

In an alternative or additional embodiment, the compensating body can be formed in one piece and/or from several compensating bodies that are firmly connected to one another. However, the compensating body is particularly preferably configured to be multipart, in particular as two parts and/or to be shaped as a half-shell, and is assembled to form the entire compensating body only when mounting at the crossbeam. Threading the compensating body on the crossbeam is therefore unnecessary. Furthermore, the shell element and the compensating body are there preferably configured such that a radial force directed at least substantially perpendicular to the longitudinal axis of the crossbeam is introduced into the compensating body and/or effected during the mounting process and/or during the mounted state. The compensating body is also preferably configured to transmit at least in part forces and/or torques arising between the crossbeam and the receptacle of the support frame.

In a preferred embodiment of the machine according to the disclosure, the shell element, in particular along the inner side, and the compensating body, in particular along an outer contact surface, are formed to be conical at least in part. This configuration allows for the shape, position and/or, size tolerances between the bearing device, in particular the shell element and the compensating body, and the crossbeam to be compensated for in a particularly simple manner. In the installed state, at least one respective contact surface of the shell element, which is formed by the inner side, abuts at least in part against at least one associated contact surface of the compensating body. The shell element and the compensating body are preferably connected to one another in a positive-fit and/or a force-fit manner, in particular in the manner of a clamping connection, where a circumferential force and/or a torque is transmittable between the inner side of the shell element and the contact surface of the compensating body. The compensating body is particularly preferably formed to be rotationally symmetrical and/or in the manner of a conus, preferably to have the shape of a cone and/or truncated cone, where in particular the contact surface facing the shell element forms the outer circumference of the compensating body. Furthermore, the inner side of the shell element and the contact surface of the compensating body are there preferably configured to correspond to one another at least in sections in terms of their shape and/or their dimensions, where both the inner side of the shell element as well as the compensating body are configured to be circumferential.

In a further development of the machine according to the disclosure, an, in particular adjustable, axial force, that corresponds at least substantially to the longitudinal axis of the crossbeam, can be generated within the bearing device, where the bearing device, in particular the shell element and/or the compensating body, is configured to convert the axial force at least in part into a radial force directed approximately perpendicular to the axial force, and where the bearing device, in particular the compensating body, is braced with the crossbeam in dependence of the radial force. The greater the axial force that is introduced and/or set, the higher the converted radial force there and therefore the pressing force with which the compensating body is braced with the shell element and/or the crossbeam. Preferably, a first pressing surface formed at the shell element which is arranged facing away from and in particular disposed opposite a second pressing surface formed at the compensating body, where the respective face sides of the pressing surfaces are aligned at least substantially perpendicular to the longitudinal axis of the crossbeam. The axial force is preferably initiated and/or set manually by an operator.

In another preferred embodiment of the machine according to the disclosure, the bearing device comprises at least one tensioning device which extends through the shell element and/or the compensating body and which comprises at least one tensioning disk arranged laterally from the outside on the shell element and/or the compensating body, and at least one tensioning body, where the axial forces can be generated and/or adjusted by way of the tensioning device. The tension device there preferably comprises at least one, in particular common, tensioning disk, a tensioning body, which is configured in particular in the manner of a screw nut, and at least one elongate element which is in particular configured in the manner of a screw. When in the installed state, the elongate element is arranged to protrude through the shell element and the compensating body. The tensioning disk is preferably associated with several tensioning bodies and/or elongate elements. In addition, the tensioning disk is preferably arranged between the receptacle of the support frame and the shell element of the bearing device. Furthermore, the tensioning disk is preferably configured to secure and/or retain the bearing device and thereby the crossbeam seen in the axial direction at the receptacle of the support frame. Particularly preferably, at least one first tensioning disk is arranged laterally from the outside at the tensioning element and at least one second tensioning disk is arranged laterally from the outside at the compensating body. The tensioning disks are therefore configured to absorb the axial force that is introduced and/or introduceable and/or to transmit it to the respective pressing surfaces and therefore to the shell element and the compensating body. The axial force can be introduced particularly evenly onto the associated pressing surface by the at least one tensioning disk, which is particularly advantageous for operational safety.

In addition, a machine according to the disclosure is preferred in which the compensating body comprises at least one in particular slot- or step-like depression in particular along an outer contact surface and the shell element comprises at least one elevation associated with the depression in particular along the inner side, in particular in the manner of a rib or step, where the compensating body and the shell element are connected to one another, in particular when viewed in the circumferential direction, in a positive-fit manner by way of the depressions and the elevation associated therewith.

Particularly preferably, the forces and/or torques introduced and/or resulting between the shell element and the compensating body are transmitted at least in part between the inner side of the shell element and the contact surface of the compensating body as well as between the depression and the elevation associated therewith. With a positive fit thus configured, the shell element and the compensating body continue to be connected to one another in a rotationally fixed manner, in particular when the clamping connection embodied between the inner side and the contact surface is overloaded and/or overcome. Particularly preferably, several depressions are formed along the compensating body and several elevations associated with the respective depressions are formed along the shell element. In an alternative or additional embodiment in which the compensating body is configured being multipart and/or in the form of a half-shell, the elevations are arranged at least in part, when viewed in the direction of rotation and/or circumferential direction, between two parts and/or segments of the compensating body.

In addition, the compensating body preferably comprises at least one inner circumference which faces the crossbeam when viewed in the circumferential direction and which in the installed state abuts directly and at least in sections against the crossbeam.

In a preferred development of the machine according to the disclosure, at least one recess is formed along the inner circumference, where the inner circumference is at least almost exclusively abutted outside the at least one recess against the crossbeam. The compensating body there along its inner circumference and/or its inner contour comprises at least one section which abuts against an outer contour of the crossbeam and/or directly against the crossbeam, while another section, which is formed along the recess, is arranged without contact with the outer contour of the crossbeam. The compensating body preferably comprises several such recesses along the inner circumference or the inner contour, respectively, which are not in contact with the crossbeam when in the installed and/or assembled state. With a crossbeam which is preferably configured as a multi-sided profile, in particular as a square, the at least one recess is preferably arranged between, in particular in the middle, between two preferably rounded corners of the crossbeam. The pressing forces and/or torques are therefore introduced and/or transmitted at least substantially via sections which are arranged in the region of the respective corners and/or adjoining the respective corners of the crossbeam. This embodiment takes advantage of the knowledge that the crossbeam has greater stability or can be subjected to greater stress in the region of the corners. This measure further increases operational safety in a particularly simple manner.

Furthermore, the crossbeam is preferably associated with at least one actuator for rotating and/or pivoting the crossbeam at least in part. The actuator can there preferably be operated remotely.

In a further preferred embodiment of the machine according to the disclosure, the actuator can be coupled via the at least one bearing device to the crossbeam, in particular by way of at least one lever device. Particularly preferably, the actuator and/or a lever device connected to the actuator are connected directly to the bearing device. As a result, the forces and/or the torque for rotating and/or pivoting the crossbeam can be introduced and/or transmitted directly into the bearing device. On the other hand, articulation points known from prior art on the crossbeam for connecting the actuator are therefore dispensed with. This measure is particularly advantageous for adjusting the position, attitude, and/or orientation of the crossbeam relative to the support frame and/or the arable land. The actuator and/or the lever device are furthermore preferably connected to the shell element and/or to the tensioning device, in particular to the tensioning disk.

### BRIEF DESCRIPTION OF THE DRAWINGS

Further details of the disclosure can be gathered from the description of the examples and the drawings. The drawing in

FIG. 1 shows an agricultural machine in a working position and in a perspective view from the front;

FIG. 2 shows a perspective view of a bearing according to the disclosure of a crossbeam coupled to the agricultural machine;

FIG. 3 shows a bearing device according to the disclosure in a sectional view from the front;

FIG. 4 shows individual components of the bearing device from FIG. 3 in an enlarged sectional view;

FIG. 5 shows the bearing device from FIG. 3 and the crossbeam in a side view; and

FIG. 6 shows an exemplary further embodiment of individual components of the bearing device according to the disclosure.

FIG. 7 shows a further embodiment of shell element according to the disclosure.

### DETAILED DESCRIPTION

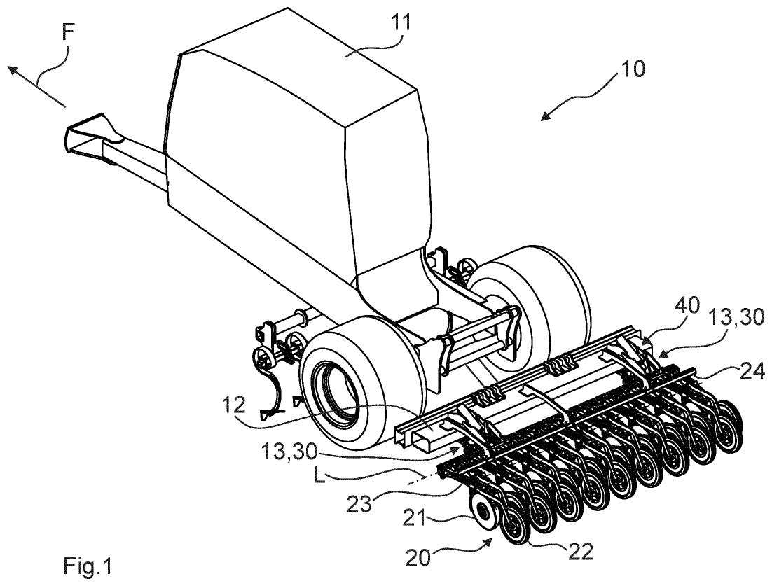

An agricultural machine 10 configured by way of example as a trailed sowing machine is shown in FIG. 1. Machine 10 there comprises a central storage container 11 for storing distribution material, in particular seeds and/or fertilizers, which can be delivered via at least one pneumatic conveying system, not shown in the figures, to several work tools 20 arranged next to one another to be transverse to a direction of travel F. Work tools 20 are shown in a lowered working position and are configured, for example, as sowing colter assemblies, each of which comprises at least one furrow opening element 21, in particular disc colter, and at least one depth guide element 22, in particular a depth guide and/or pressure roller. Alternatively or additionally, at least a device for closing the furrow can also be associated with a respective work tool 20. Machine 20 is configured by way of work tools 20 to deposit the distribution material as needed on the agricultural arable land, in particular within a furrow provided for this purpose.

It is presently to be pointed out explicitly again that the embodiment of machine 10 shown is only by way of example and can alternatively or additionally also comprise work tools 20 configured as soil cultivation tools, for example, as a grubber. In addition, machine 10 can alternatively also be configured as an agricultural soil cultivation machine.

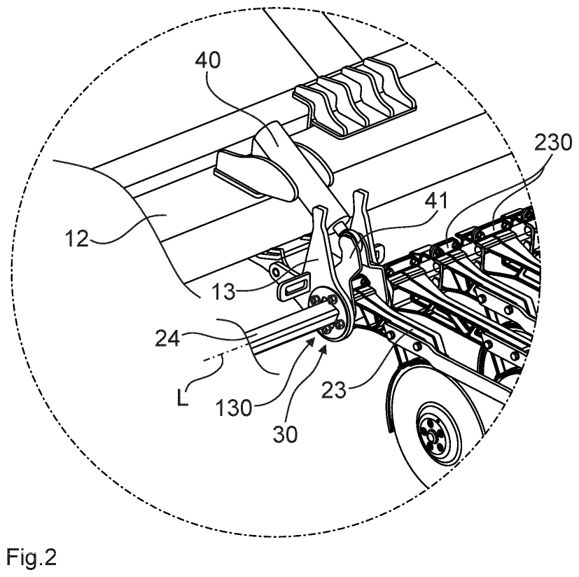

The coupling of work tools 20 to machine 10 can be seen in the closer view in FIG. 2. According thereto, machine 10 comprises a machine frame 12 with which a support frame 13, in particular configured in the manner of a longitudinal beam, with a receptacle 130 is associated. Support frame 13 is connected there by way of example to machine frame 12. Alternatively or additionally, support frame 13 can also be part of machine frame 12 and/or integrated thereinto. Support frame 13 is configured by way of receptacle 130 to receive at least one crossbeam 24 that is at aligned least substantially to be transverse to direction of travel F. Machine 10 further comprises at least one multi-part bearing device 30, in particular associated with receptacle 130, by way of which crossbeam 24 is arranged at receptacle 130 so as to be rotatable about its longitudinal axis L. Respective work tools 20 are each articulated to crossbeam 24 by way of a steering arm 23 and an overload protection 230.

Crossbeam 24 is also associated with at least one actuator 40 which is configured to rotate and/or pivot at least in part crossbeam 24 and therefore work tools 20. Work tools 20 can therefore be adjusted at least in part, in particular remotely, by way of actuator 40 in their height, position and/or orientation relative to support frame 13 and/or the arable land. For example, work tools 20 can therefore be moved in an adjustable manner between at least two different positions, in particular a working and a transport position, and/or to different penetration depths into the ground.

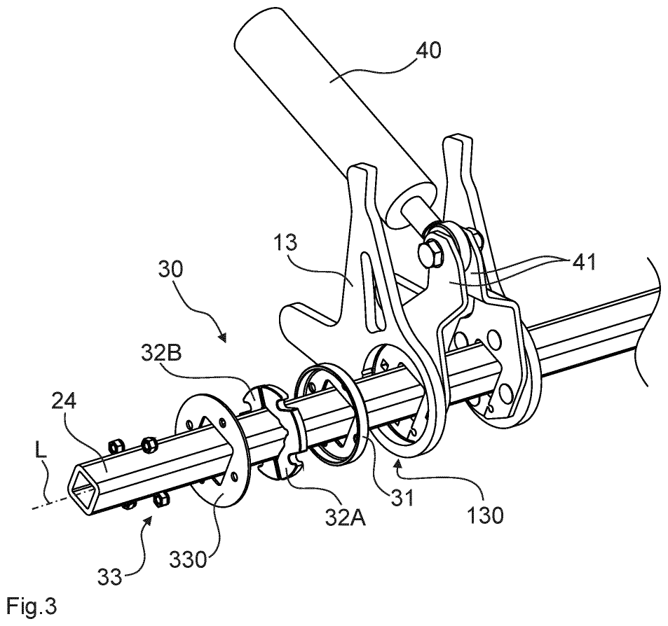

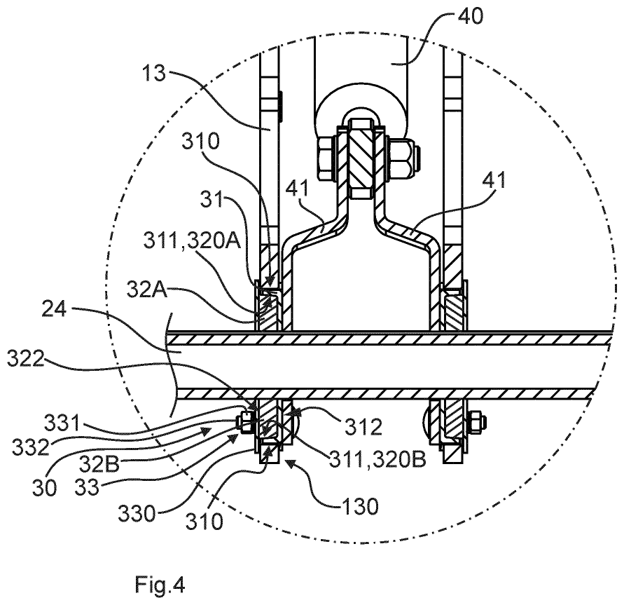

FIGS. 3 and 4 show bearing device 30 in an enlarged view. Accordingly, bearing device 30 comprises at least one, in particular a one-piece, shell element 31 which, in particular when viewed in the circumferential direction, comprises an outer side 310 facing receptacle 130 and an inner side 311 facing crossbeam 24. As an alternative to the embodiment shown, shell element 31 can also be configured as several parts on at least two half-shells. Arranged between inner side 311 of shell element 21 and crossbeam 24 is also an, in particular multi-part and/or half-shell-shaped, compensating body 32A, 32B, by way of which crossbeam 24 is connected in a rotationally fixed manner to bearing device 30, in particular to shell element 31.

Shell element 31 and compensating body 32A, 32B are configured such that bearing device 30, in particular shell element 31 and/or compensating body 32A, 32B, in an assembled state is braced with crossbeam 24, in particular in a force-fit manner and/or in the manner of a clamping connection.

For mounting bearing device 30, shell element 31 is threaded onto crossbeam 24 up to receptacle 130 and/or pushed along crossbeam 24. Compensating body 32A, 32B is inserted into shell element 31 before or after the threading and/or pushing process.

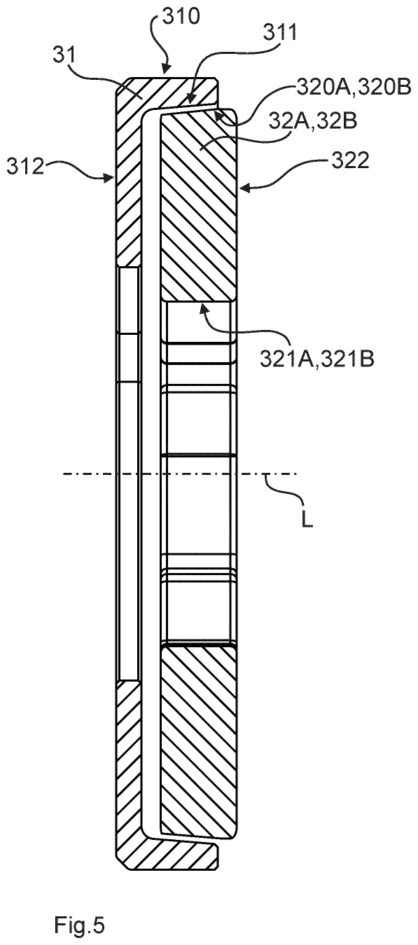

Furthermore, as can be seen well in FIGS. 4 and 5, shell element 31, in particular along inner side 311, and compensating body 32A, 32B, in particular along an outer contact surface 320A, 320B, are formed to be conical at least in part and/or in sections. Inner side 331 of shell element 31 and contact surface 320A, 320B of compensating body 32A, 32B are configured there to correspond to one another and are connected to one another in a force-fit manner such that a circumferential force and/or a torque can be transmitted between inner side 311 and contact surface 320A, 320B.

In order to connect shell element 31 and compensating body 32A, 32B to one another in a force-fit manner and thereby brace bearing device 30 with crossbeam 24, an in particular adjustable axial force that corresponds at least substantially to longitudinal axis L of crossbeam 24 can be generated within bearing device 30. This axial force is adjusted and/or introduced manually by way of a tensioning device 33 which extends through shell element 31 and/or compensating body 32A, 32B and which comprises at least one tensioning disk 330 arranged laterally from the outside on shell element 31 and/or compensating body 32A, 32B and at least one tensioning body 331. Tensioning device 33 there furthermore comprises an elongate element 332, where elongate element 332 is configured by way of for example as a screw and tensioning body 331 as a screw nut. Tensioning disk 330 is configured in particular as one piece and is associated with a plurality of tensioning bodies 331 and elongate elements 332. Alternatively, tensioning disk 330 can also be configured to be multipart, where the individual parts of tensioning disk 330 are connected and/or connectable to one another in particular in a puzzle-like manner.

In addition, shell element 31 and/or compensating body 32A, 32B are configured to convert at least in part the axial force into a radial force that is directed approximately perpendicular to the axial force. Bearing device 30, in particular compensating body 32A, 32B, is braced with crossbeam 24 in dependence of the magnitude of the radial force and is thus connected to crossbeam 24 in a force-fit manner. While it is true that the greater the axial force that is introduced and/or set, the higher the converted radial force and therefore the pressing force with which compensating body 32A, 32B is braced with shell element 31 and/or crossbeam 24. In order to introduce and/or transmit the axial force as uniformly and/or as widespread as possible, a first pressing surface 312 is formed at shell element 31 and a second pressing surface 322 arranged facing away therefrom is formed at compensating body 32A, 32B. The respective face sides of pressing surfaces 312, 322 are arranged at least substantially perpendicular to longitudinal axis L of crossbeam 24, where tensioning disk 330 is arranged abutting against second pressing surface 322 of compensating body 32. Tensioning disk 330 is further configured to secure and/or retain bearing device 30 and thereby crossbeam 24 in at least an axial direction at receptacle 130 of support frame 13.

As can likewise be seen well in FIG. 4, actuator 40 is coupled by way of at least one bearing device 30 to crossbeam 24, in particular by way of at least one lever device 41. For this purpose, actuator 40 is connected by way of lever device 41 directly to bearing device 30, in particular by way of tensioning device 33 with shell element 31. Crossbeams 24 can therefore be coupled to machine 20 and are free of additional articulation points and/or receptacles and therefore are attachable particularly flexibly relative to support frame 13 and/or the arable land.

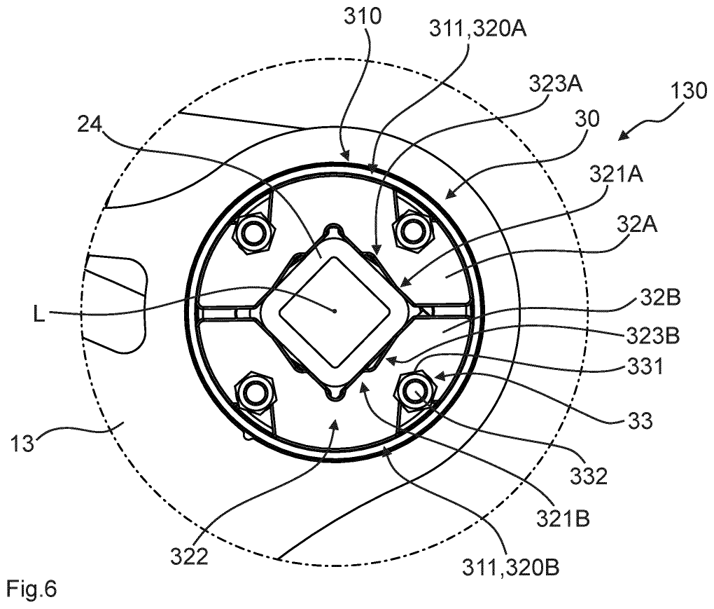

With tensioning disk 330 being hidden, it can be seen in FIG. 6 that compensating body 32A, 32B, when viewed in the circumferential direction, comprises at least one inner circumference 321A, 321B facing crossbeam 24. In the installed state, inner circumference 321A, 321B is arranged at least in sections abutting against crossbeam 24, in particular against the outer circumference or the outer contour of crossbeam 24. At least one recess 323A, 323B is formed along inner circumference 321A, 321B, so that inner circumference 321A, 321B is at least almost exclusively abutted outside at least one recess 323A, 323B against crossbeam 24. The embodiment shown there by way of example shows a plurality of recesses 323A, 323B which are formed along inner circumference 321A, 3211B, where recesses 323A, 323B are each arranged at least approximately centrally between two corners along the outer contour of crossbeam 24, which is configured by way of example as a square tube. This advantageous embodiment contributes to the pressing forces and/or torques that can be introduced and/or transmitted into bearing device 30 being introduced and/or transmitted at least substantially via sections that are arranged in the region of the respective corners and/or adjoining the respective corners of crossbeam 24.

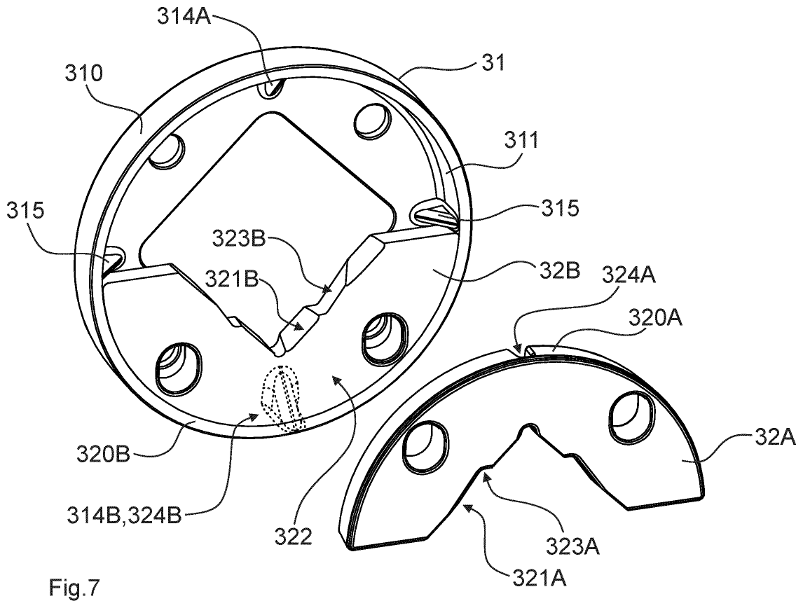

FIG. 7 shows a further embodiment of shell element 31 according to the disclosure and of compensating body 32. Compensating body 32A, 32B comprises, in particular along its outer contact surface 320A 320B, at least one in particular slot- or step-like depression 324A, 324B. Formed on shell element 31 is an elevation 314A, 314B associated with and/or corresponding to depression 324A, 324B, in particular in the manner of a rib or step. Compensating body 32A, 32B and shell element 31 are connected to one another in a positive-fit and/or force-transmitting manner by way of respective depressions 324A, 324B and elevations 314A, 314B abutting against and/or engaging with one another. Depressions 324A, 324B and elevations 314A, 314B are configured, in particular when overloading and/or overcoming the force fit along contact surface 320A, 320B and inner side 311, to transmit at least in part the forces and/or torques that can be introduced into bearing device 30. In addition, as shown in FIG. 7, further elevations 315 can be arranged and in the installed state are arranged between a first and second compensating body element in a compensating body 32A, 32B that is configured to be multi-part.

It goes without saying that the features mentioned in the embodiments described above are not restricted to these special combinations and are also possible in any other combination. Furthermore, it goes without saying that the geometries shown in the figures are only by way of example and are also possible in any other configuration.

List of reference characters

| | |
|---|---|
| 10 | agricultural machine |
| 11 | storage container |
| 12 | machine frame |
| 13 | support frame |
| 130 | receptacle |
| 20 | work tool |
| 21 | furrow opening elements |
| 22 | depth control element |
| 23 | steering arm |
| 230 | overload protection |
| 24 | crossbeam |
| 30 | bearing device |
| 31 | shell element |
| 310 | outer side |
| 311 | inner side |
| 312 | first pressing surface |
| 314A, 314B | elevation |
| 315 | further elevation |
| 32a, 32b | compensating bodies |
| 320A, 320B | contact surface |
| 321A, 321B | inner circumference |
| 322 | second pressing surface |
| 323A, 323B | recess |
| 324A, 324B | depression |
| 33 | tensioning device |
| 330 | tensioning disk |
| 331 | tensioning body, screw nut |
| 332 | elongate element, screw |
| 40 | actuator |
| 41 | lever device |
| F | direction of travel |
| L | longitudinal axis of the crossbeam |

1. An agricultural machine, comprising
at least one support frame that is associated with said machine and comprises at least one receptacle for at least one crossbeam aligned to be substantially transverse to a direction of travel of said machine,
at least one bearing device by way of which said crossbeam is arranged at said receptacle so as to be rotatable at least in part about its longitudinal axis,
wherein said bearing device comprises at least one shell element which when viewed in the circumferential direction, comprises an outer side facing said receptacle and an inner side facing said crossbeam, wherein at least one compensating body is arranged between said inner side and said crossbeam by way of which said crossbeam is connected in a rotationally fixed manner to said shell element, characterized in that said shell element and said compensating body are configured such that said bearing device and/or said compensating body, in an assembled state is/are braced with said crossbeam in a force-fit manner and/or in the manner of a clamping connection.

2. The machine according to claim 1, wherein said shell element along said inner side, and said compensating body along an outer contact surface, are formed to be conical at least in part.

3. The machine according to claim 2, wherein an adjustable, axial force that corresponds at least substantially to the longitudinal axis of said crossbeam can be generated within said bearing device, wherein said shell element and/or said compensating body, is configured to convert the axial force at least in part into a radial force directed approximately perpendicular to the axial force, and wherein said compensating body, is braced with said crossbeam in dependence of the radial force.

4. The machine according to claim 3, characterized in that said bearing device comprises at least one tensioning device which extends through said shell element and/or said compensating body and which comprises at least one tensioning disk arranged laterally from the outside at said shell element and/or said compensating body, and at least one the tensioning body, wherein the axial forces can be generated and/or adjusted by way of said tensioning device.

5. The machine according to claim 1, characterized in that said compensating body comprises at least one slot- or step-like depression along an outer contact surface and said shell element comprises at least one elevation associated with said depression along said inner side in the manner of a rib or step, wherein said compensating body and said shell element are connected to one another when viewed in the circumferential direction, in a positive-fit manner by way of said depressions and said elevation associated therewith.

6. The machine according to claim 1, wherein said compensating body comprises at least one inner circumference which faces said crossbeam when viewed in the circumferential direction and which in the installed state abuts directly and at least in sections against the crossbeam wherein at least one recess is formed along said inner circumference; and said inner circumference is abutted at least almost exclusively abutted outside said at least one recess against said crossbeam.

7. The machine according to claim 1, wherein said crossbeam is associated with at least one actuator for rotating and/or pivoting said crossbeam, wherein said actuator can be coupled by way of at least one bearing device to said crossbeam by way of at least one lever device.
